(19) United States
(12) Patent Application Publication
(10) Pub. No.: US 2008/0246226 A1
(43) Pub. Date: Oct. 9, 2008

(54) Universal shaftseals

(76) Inventor: Yoshioki Tomoyasu, Fujisawa-shi (JP)

Correspondence Address: Yoshioki Tomoyasu, 21-22 Mirokuji 3-chome, Fujisawa-shi, Kanagawa-ken, 251-0016, JP

(21) Appl. No.: 11/784,348

(22) Filed: Apr. 9, 2007

(51) Int. Cl. F16J 15/16

(52) U.S. Cl. 277/500

(57) ABSTRACT

The invention is directed to developing for the high sealing capacity of the Shaftseals by means of applying elastic cylinder of which both inside and outside surfaces are either inclined or plain to be fixed on the opening of the housing in being compressed onto the surface of the rotating shafts at the inside rubber cylinder.

### FIELD OF THE INVENTION

The present invention is generally directed to developing for the high sealing capacity of the device to prevent fluids such as air and oil from leaking through the gap between the rotating shaft and the housing.

### BACKGROUND OF THE INVENTION

In parallel with the development of the efficient capacity of the performance of either machine or device, the high sealing capacity as well as the manufacturing costs corresponding to the advancement are required for further progress in the industry. Whereas, the shaftseals have been suffered from being insufficient for the requirements for the sealing capacity as well as the manufacturing cost.

### SUMMARY OF THE INVENTION

The present invention is directed to develop for the efficient sealing capacity of the rotating shaftseals capable of withstanding under the high pressure even in the event that the centrifugal force is increased in proportion to the rotating speed of said shaftseals by using rubber cylinder allowing to cover the surface of said rotating shaft with the wide range of the elastic inside wall, thus enabling to exert stronger sealing force than either those of thin rubber lip like a lip seals or those of rubbing the mutual surfaces of the ring cylinders like the mechanical seals.

### BRIEF DESCRIPTION OF THE DRAWINGS

FIG. 1: One example of the cross side view of the universal shaftseals.

FIG. 2: One example of the cross side view of the universal shaftseals in actual application into the space between the surface of the rotating shaft and the opening of the housing of the machine.

### DETAILED DESCRIPTION OF THE INVENTION

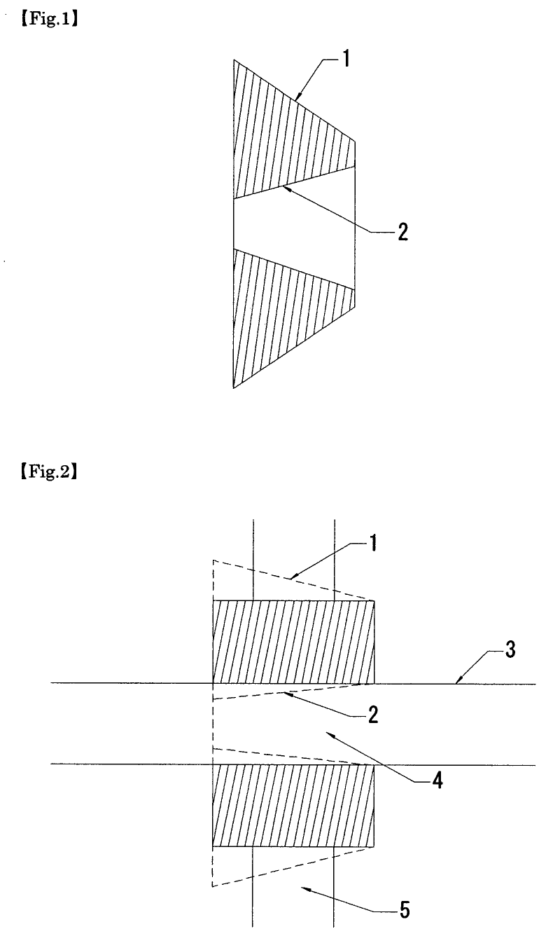

As shown FIG. 1, the present invention is directed to developing for the high sealing capacity of the shaftseals consisting of the rubber cylinder with either plain or inclined outside (1) and inside (2) surface to be applied into the space between the opening (4) of the housing (5) to be fixed closely and the rotating shaft (3) of which surface is compressed with the elastic band constituting said inside surface (2) of said rubber cylinder which allow to make arrangement for proper force being prevented the fluid in the housing (5) from leaking through the gap therebetween by dint of the reactive force against said opening (4) plate.

On the other hand, the design idea for the conventional lip seals depend on finding a shape in thin rubber ring to be compressed onto the surface of said rotating shaft (3) to keep the strong sealing capacity for fear that wide range of width of the rubber lip in contact with the surface of said rotating shaft (3) should be entailed with heavy load in rotating operation.

However, the compressive force of said thin rubber lip also have been suffered from heavy lord in rotating operation of said rotating shaft (3). The emphasis must be placed on strengthening the sealing capacity which is available for wide range of rubber band of said rubber cylinder capable of making arrangement for correlation between compression and load involved in rotating operation of said rotating shaft (3) which is liable to be required for accelerating rotating speed in the actual application for the machines and devices in parallel with further development in performance attributable to the reason that the width of rubber band in contact with the surface of said rotating shaft (3) is in proportion to the sealing capacity as well as the load in rotating operation, thus the wider room for selection for keeping balance on allotment between compressive force and the range of the width of the rubber ring in contact with the rotating shaft (3) in designing for shaftseals is available for Universal Shaftseals in view of the mechanism.

As far as the mechanical seals are concerned, they depend mainly upon pressing surfaces of mutual ring cylinders supported by the spring indirectly. On the other hand, this invention is designed to contact directly with mutual surfaces of said rubber cylinder and said rotating shaft (3), thus the friction is more closely as well as strongly than those of the mechanical seals. Eventually the sealing capacity of said rubber cylinder are much superior to those of the mechanical seals from the mechanical point of view.

Furthermore, the rubber cylinder of this invention is easier to install and be available for much lower manufacturing costs due to simple mechanism.

1. Universal shaftseals is designed to prevent the fluids from leaking through the gap between the inside surface of the elastic cylinder fixed on the opening of the housing and the surface of the rotating shaft.

2. Universal shaftseals is designed to seal the fluid with the wider band of the elastic cylinder compressed onto the surface of the rotating shaft than the thin rubber ring of the conventional lip seals in width.

3. Universal shaftseals is either inclined with some angle or plain on the outside as well as the inside surfaces of the elastic cylinder consisting of a single material.
